(19) United States
(12) Patent Application Publication
(10) Pub. No.: US 2012/0278728 A1
(43) Pub. Date: Nov. 1, 2012

(54) DOWNLOAD MONITORING IN A MEDIA DISTRIBUTION SYSTEM

(75) Inventors: David Malin, Great Neck, NY (US); Robert Sosinski, North Bergen, NJ (US)

(73) Assignee: SLING MEDIA INC., Foster City, CA (US)

(21) Appl. No.: 13/098,198

(22) Filed: Apr. 29, 2011

(51) Int. Cl. G06F 15/16; G06F 3/01

(52) U.S. Cl. 715/748; 709/217

(57) ABSTRACT

Systems and methods are provided for monitoring downloading of media programs to media devices over a network. One exemplary method involves providing, to a message server communicating with the media device over the network, a download request for downloading the media program from a content source coupled to the network to the media device, receiving, from the message server, status information for the download of the media program by the media device, and providing, to a client device coupled to the network, the download status information received from the message server.

### TECHNICAL FIELD

The following discussion generally relates to monitoring the status of downloads of media programs by media devices in media distribution systems.

### BACKGROUND

Media content can now be received from any number of different sources in a number of different ways. For example, live or recorded content can be “placeshifted” from a user's media device, such as a set-top box (STB), a digital video recorder (DVR), or the like, over the Internet or another network to allow viewing at remote locations. Additionally, content may be made available “on-demand” for downloading to the user's media device for more immediate viewing. In practice, however, latencies impair a user's ability to remotely monitor the download status of the on-demand content to the user's media device. As a result, it is now desirable to create systems and methods for improved monitoring of downloads to a media device (e.g., DVR, STB, or the like) over a network. Other desirable features and characteristics may also become apparent from the subsequent detailed description and the appended claims, taken in conjunction with the accompanying drawings and this background section.

### BRIEF SUMMARY

According to various exemplary embodiments, systems and methods are presented for monitoring downloading of media programs to media devices over a network. One exemplary method executable by a processing system involves providing, to a server communicating with the media device over the network, a download request for downloading the media program from a content source coupled to the network to the media device, receiving, from the server, status information for the download of the media program by the media device, and providing, to a client coupled to the network, the status information received from the server.

In other embodiments, a method executable by a message server coupled to a network involves receiving, from a host server coupled to the network, a download request for a media program available from a content source coupled to the network, and providing the download request to a media device coupled to the network, wherein the media device begins downloading the media program from the content source in response to the download request. After providing the download request to the media device, the message server continues by obtaining download status information for the media program from the media device and providing the download status information to the host server.

In another embodiment, a media distribution system is provided that facilitates communication with a client and a media device via a network. An exemplary media distribution system includes a message server coupled to the network to establish a connection with the media device over the network, and a host server coupled to the network and communicating with the message server and the client via the network to receive, from the client, indication of a media program available from a content source coupled to the network and provide a download request for the media program to the message server. The message server provides the download request to the media device via the connection, and the media device begins downloading the media program from the content source over the network in response to the download request. The host server receives, from the message server, status information for the downloading of the media program to the media device and provides the status information to the client.

Still other embodiments relate to a media device. An exemplary media device includes a network interface configured to support a first connection with a message server over a network and a second connection with a content source over the network, a digital video recorder coupled to the network interface, and a control module coupled to the network interface and the digital video recorder. The control module and the network interface are cooperatively configured to initiate a download of the media program from the content source to the digital video recorder via the second connection in response to a download request from the message server, receive a status request from the message server, and provide download status information to the message server in response to the status request. The message server provides the download status information to a host server coupled to the network for provision to a client device coupled to the network.

Various embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary media distribution system;

FIG. 2 is a flowchart of an exemplary download process suitable for use with the media distribution system of FIG. 1;

FIG. 3 is a diagram of illustrating communication within the media distribution system of FIG. 1 in accordance with an exemplary embodiment of the download process of FIG. 2; and

FIGS. 4-7 illustrate a sequence of a user interface display presented by a portal application in the media distribution system of FIG. 1 in connection with the download process of FIGS. 2-3 in accordance with one or more exemplary embodiments.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Embodiments of the subject matter described herein generally relate to providing information to a user regarding the status (or progress) of media programs being downloaded to the user's media device over a network. As described in greater detail below, the user operates a client device to communicate with a host server over the network to indicate a desire to download a particular media program available for downloading on-demand from an on-demand programming source to the user's media device, such as a set-top box, a digital video recorder, or the like. The host server receives indication of the desired media program, and provides a download request for obtaining the desired media program from the on-demand programming source to a message server. The message server establishes or otherwise maintains a persistent connection with the user's media device, and forwards or otherwise provides the download request to the user's media device over the network using the persistent connection. In response to receiving the download request, the media device establishes a connection with the on-demand programming source and begins downloading the desired media program from the on-demand programming source over the network. Subsequently, the message server provides status requests to the media device over the persistent connection, and in response to the status requests, media device replies with status information indicating the download progress (e.g., the amount or percentage of the media program that has been downloaded to the media device) along with other download information, such as the data rate between the media device and the on-demand programming source. The message server receives the download status information from the media device and provides the received download status information to the host server for provision to the user.

In an exemplary embodiment, the host server displays or otherwise provides a graphical representation of the download status (or progress) received from the media device via the message server on the client device. In accordance with one or more embodiments, the message server periodically requests and receives the download status information from the media device, such that the host server periodically updates the display on the client device to reflect the most recently received download status information. As described in greater detail below, based on the progress of the download and/or the data rate between the media device and the on-demand programming source, the host server determines when the downloaded media program is available for streaming from the media device to the client device, and in response, updates the display on the client device to allow a user to select or otherwise indicate a desire to stream the downloaded media program from the media device to the client device. In response to receiving indication of a desire to stream the download media program, the host server provides streaming instructions for streaming the downloaded media program to the client device to the message server, which, in turn, provides the streaming instructions to the media device. In response to the streaming instructions, the media device establishes a connection with the client device over the network and creates a placeshifting session, wherein the downloaded media program is streamed from the media device and viewed on the client device.

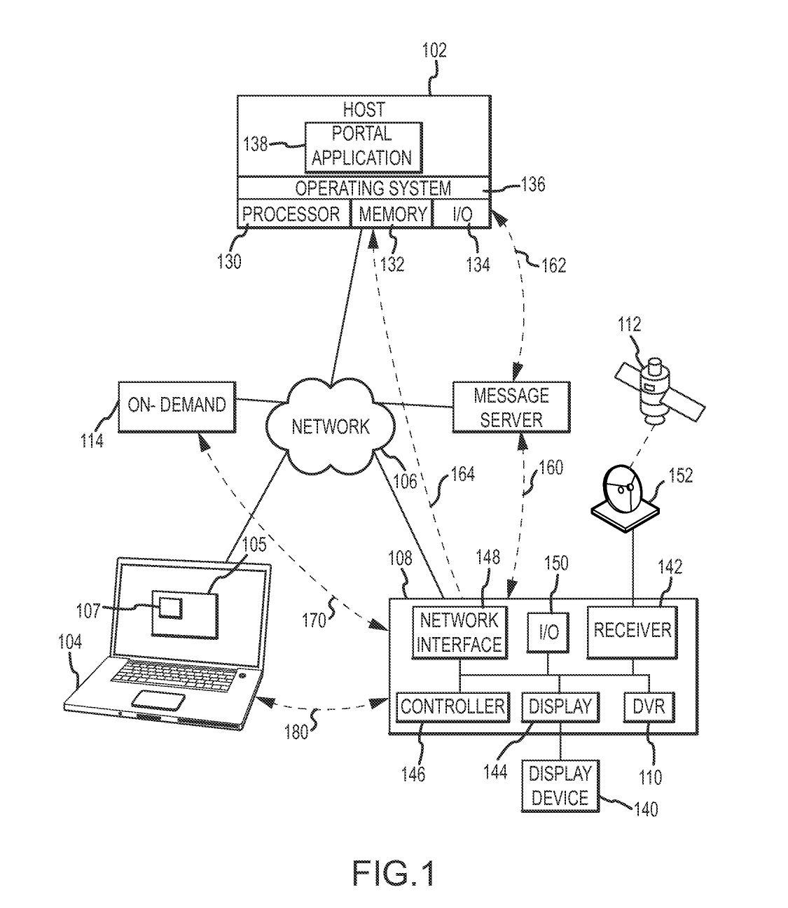

FIG. 1 depicts an exemplary embodiment of a media distribution system 100 for distributing media programs (or media content) from any number of content sources. As used herein, “media program” (or “program”), “media content” (or “content), or variants thereof should be understood as referring to any audio, video, audio/visual or other programming in any streaming, file-based or other format. In various embodiments, media distribution system 100 distributes television, movie and/or other audiovisual programs in any digital format, such as MPEG, Windows Media, Adobe Flash, Quicktime, Real Media, H.264 and/or the like, over a network 106 for presentation to a user (or viewer) on a media playback device 104 (or client device), such as a desktop or notebook computer, mobile telephone, personal digital assistant, video game player, portable media player and/or any other device capable of receiving media programs via a network 106 and of rendering audio and/or visual content. The exemplary media distribution system 100 of FIG. 1 includes a host server 102 (or host) that communicates or otherwise interacts with the client device 104 (or client) over network 106 to provide the user of the client device 104 with status information pertaining to the download of a media program from an on-demand programming source 114 to a media device 108 associated with the user, as described in greater detail below.

The client 104 may be any device, component, module, hardware, software application and/or the like that is capable of communicating with the host 102 over network 106. To that end, many different types of clients 104 may be implemented with any sort of general or special purpose hardware, software and/or firmware. In some embodiments, client 104 may be a conventional personal computer, portable computer, workstation and/or other computing system. In still other embodiments, some types of clients 104 may include personal digital assistants, video game players, mobile telephones, network appliances, remote controls, networked displays and/or any other devices capable of communicating on network 106.

In the embodiment shown in FIG. 1, client 104 executes any sort of conventional browser or other application 105 that is compatible with standard Internet, world wide web (WWW), transmission control protocol and/or internet protocol (TCP/IP), and/or other formats. Such browsers 105 are typically capable of displaying active or other documents formatted in accordance with published protocols (e.g., hypertext markup language (HTML), extensible markup language (XML), and/or the like). Many browsers 105 are also capable of executing “plugin” applications, applets or the like. Such plugins may be formatted in accordance with ActiveX, JAVA and/or any number of other formats. A number of commonly used web browsers are available for a number of different computing platforms, and the subject matter described herein is not limited to any particular browser application.

In some embodiments, client 104 further includes a media player application 107. This media player 107 may be a standalone player, or the media player 107 may be implemented as a plugin or other applet that runs within browser 105 as desired. In some embodiments, media player 107 is initially obtained from a networked host, such as host 102. The media player 107 may be retrieved on an as-needed basis in some embodiments, or may be stored at client 104 for subsequent execution. Some embodiments may not provide media viewing directly on client 104; such clients 104 may nevertheless be able to interact with host 102 to search for particular programming, to select programs to record, to change preferences, or to take other actions related to media device 108 as desired.

The network 106 is any digital or other communications network capable of transmitting messages between senders (e.g., client 104) and receivers (e.g., host 102). In various embodiments, network 106 includes any number of public or private data connections, links or networks supporting any number of communications protocols. Network 106 may include the Internet, for example, or any other network. Such networks may be based upon TCP/IP or other conventional protocols, although other embodiments may use any type of alternate or successor protocols, as desired. In various embodiments, network 106 may also incorporate a wireless and/or wired telephone network, such as a cellular communications network for communicating with mobile phones, personal digital assistants, and/or the like. Various embodiments of network 106 may also incorporate any sort of wireless or wired local area networks (LANs), wide area networks (WAN), or the like.

In an exemplary embodiment, the media device 108 is any component, hardware and/or the like capable of receiving and processing media content. In some embodiments, media device 108 is a set-top box (STB) or similar system that is able to receive television programming and/or to record certain programs that can be viewed on a display device 140, such as a television, monitor, liquid crystal display (LCD), light emitting diode (LED) display, plasma display, or the like. Exemplary embodiments of media device 108 will therefore include a receiver interface 142 for receiving satellite, cable and/or broadcast programming signals from broadcast sources 112, as well as a data storage medium 110 (e.g., a hard disk, flash memory, or another suitable non-volatile data storage element) to support a digital video recorder (DVR) feature and/or functionality, a display interface 144 for providing imagery to the display device 140, and a control module 146 that directs the operations of the media device 108 as appropriate. For convenience, but without limitation, the data storage medium 110 is alternatively referred to herein as a DVR. Media device 108 may also include an interface 148 to network 106 and/or an input/output interface 150 to a remote control or other device for providing user inputs to media device 108, as appropriate.

The components in media device 108 may be provided within a common chassis or housing as shown in FIG. 1, although equivalent embodiments may implement media device 108 with any number of inter-connected but discrete components or systems. For example, in some embodiments, the media device 108 may be realized as a combination of a STB and a placeshifting device, wherein some features of the media device 108 (e.g., the DVR 110, the receiver 142, the display interface 144, and/or I/Os 150) are implemented by the STB and other features of the media device 108 (e.g., the network interface 148) are implemented by the placeshifting device, wherein the placeshifting device works in conjunction with the STB to shift the viewing experience from a home television (e.g., display device 140) to a viewing display on the client device 104 (e.g., media player application 107) that is accessed via network 106. Examples of placeshifting devices that may be used in some embodiments of media device 108 could include any of the various SLINGBOX products available from Sling Media of Foster City, Calif., although other products or servers could be used in other embodiments. Many different types of placeshifting devices are generally capable of receiving media content from an external source, such as any sort of DVR or STB, cable or satellite programming source, DVD player, and/or the like. In other embodiments, placeshifting features are incorporated within the same device that provides content-receiving or other capabilities. Media device 108 may be a hybrid DVR and/or receiver, for example, that also provides transcoding and placeshifting features. Examples of conventional placeshifting functions, features, systems and structures are described in United States Patent Publication No. 2006/0095471, although the features described herein could be equivalently applied with any number of other techniques and structures in addition to those described in that particular publication. It should be appreciated that FIG. 1 depicts merely one exemplary embodiment of a media device 108, and in practice, the media device 108 may be logically and physically implemented in any manner to suit the needs of a particular embodiment.

In the exemplary embodiment illustrated in FIG. 1, media device 108 is capable of receiving digital broadcast satellite (DBS) signals transmitted from a broadcast source 112, such as a satellite, using an antenna 152 that provides received signals to the receiver 142. Equivalent embodiments, however, could receive programming at receiver 142 from any sort of cable connection, broadcast source, removable media, network service, external device and/or the like. The DVR 110 feature stores recorded programming (e.g., broadcast programming received via receiver 142) on a hard disk drive, memory, a networked server, or other storage medium as appropriate in response to user/viewer programming instructions, wherein the recorded programming may be subsequently viewed on display device 140 or client device 104 via network 106. Content stored in DVR 110 may be any sort of file-based programming or other content that is accessible to media device 108. In various embodiments, in addition to storing broadcast programming, the DVR 110 may also store programming received from another source within the media distribution system 100, such as, for example, programming downloaded from an on-demand programming source 114, as described in greater detail below. Additionally, content in DVR 110 may be stored in any sort of compressed or uncompressed format, as desired, and may be encoded or transcoded as desired for effective receipt, storage, retrieval and playing.

The control module 146 is any sort of hardware, software and/or firmware capable of directing the operations of media device 108. In various embodiments, control module 146 includes software or firmware logic residing in memory and executing on any sort of processor, such as any sort of microprocessor, microcontroller, digital signal processor or the like. In various embodiments, the control module 146 is based upon a “system on a chip” (SoC) implementation that incorporates a hybrid microcontroller with memory, input/output and other features to perform the various signal processing and other actions of media device 108. Other embodiments may implement control module 146 and/or the other features of media device 108 with any number of discrete and/or integrated processing components (e.g., any sort of microprocessor or microcontroller), memories, input/output features and/or other features as desired. As described in greater detail below, in accordance with one or more embodiments, the control module 146 communicates with the network interface 148 and the DVR 110 to receive a download request for a media program available for download from the on-demand programming source 114, establish a connection 170 to the on-demand programming source 114 over the network 106, and initiate a download of that media program from the on-demand programming source 114 to the DVR 110 via connection 170. Additionally, the control module 146 is configured to determine the progress or amount of the media program that has been downloaded to the DVR 110 along with the data rate between the media device 108 and the on-demand programming source 114, and provides the download status information (e.g., download progress and data rate) in response to receiving download status requests from other devices on the network 106. The control module 146 is also capable of establishing a connection 180 to the client 104 and supporting streaming of downloaded media programs from the DVR 110 to the client 104 over the network 106 via the connection 180, as described in greater detail below.

In the illustrated embodiment of FIG. 1, the host 102 generally represents one or more servers or another network host capable of interacting with a client 104 to facilitate communications between the client 104 and the media device 108 associated with the user or operator of the client 104 via the host 102, and also, provide information to the client 104 regarding media programming available from various content sources within the media distribution system 100, such as, for example, broadcast sources 112, on-demand sources 114, or like, along with the user's DVR 110, as described in greater detail below. The host 102 may be implemented with a server computer system or data processing system that is based upon any processor, architecture and/or operating system, and will typically be implemented using any sort of conventional processing hardware 130, memory 132 and input/output features 134. Various embodiments may be implemented using dedicated or shared hardware servers; other implementations may make use of virtual server features as part of a “cloud computing” service, such as any of the cloud computing services provided by any number of providers. Although FIG. 1 shows a single host 102 for convenience, many practical embodiments of media distribution system 100 may provide a cluster or other collection of multiple hosts 102 to support any desired number of simultaneous connections to multiple clients 104 and/or multiple media devices 108. This cluster may also incorporate appropriate routing, load balancing, access and security mechanisms and or any number of other features. In various embodiments, each host 102 is an actual or virtual computer system executing an operating system 136 in conjunction with the processing hardware 130, memory 132 and/or I/O features 134 to provide a computing core that is capable of executing a portal application 138, as well as any number of daemons, processes, applications or other instance modules as desired. For example, a portal application 138 could execute as a daemon on host 102, with connections to separate clients 104 being managed as separate processes or instances that communicate with portal application 138 using features provided by operating system 136.

In response to requests received from client 104 to retrieve information from the media device 108 and/or to provide instructions to the media device 108. the processor 130 and/or portal application 138 are configured to establish communication sessions over network 106 with the media device 108 via one or more message servers 116 that have a pre-established connection 160 with the media device 108. In an exemplary embodiment, the message server 116 is implemented using conventional computer server hardware, software and/or services, such as any of the hardware or software features described above in connection with host 102. The message server 116 typically receives a request from the media device 108 to initiate a persistent connection 160 using a uniform resource locator (URL), IP address, or other network address that can be readily contacted on network 106. For example, in accordance with one or more embodiments, the message server 116 is realized as a TCP server that is automatically accessed when media device 108 starts up, reboots, or otherwise initiates activity on network 106. In such cases, the media device 108 contacts the message server 116, establishes a TCP or similar connection 160, and then awaits further action. This connection 160 may be kept alive using relatively low bandwidth “keep alive” features that are part of the TCP protocol. By pre-establishing the connection 160 from the media device 108 to the message server 116, a pre-existing connection is maintained that can be used to send instructions or requests to the media device 108, even when the media device 108 is behind a firewall or other security mechanism. The connection 160 between media device 108 and message server 116 can be used to establish a separate connection 164 between the media device 108 and the host 102, as described in greater detail below. Additionally, the connection 160 between media device 108 and message server 116 can be used to transmit download requests or instructions from the host 102 to the media device 108 to establish a separate connection 170 with the on-demand programming source 114 for downloading media programming from the on-demand programming source 114, as described in greater detail below.

In an exemplary embodiment, a user of the client 104 is able to connect to the portal application 138 supported by host 102 via the network 106, for example, by directing a browser 105 or similar program to a URL or other address associated with host 102 and/or portal application 138. After the user is successfully authenticated by the portal application 138, the host 102 and/or portal application 138 establishes a connection 162 to the message server 116 and provides instructions which are transmitted by the message server 116 to the media device 108 via connection 160 to establish a connection 164 between the host 102 and/or portal application 138 and the media device 108 that is used by the portal application 138 to obtain information about programming stored at the media device 108, such as, for example, a listing of the programs stored on DVR 110. In this regard, the message server 116 can transmit an instruction over the pre-existing connection 160 that directs media device 108 to separately contact host 102 and to establish an appropriate communication session to host 102 and provide information about programming stored at the media device 108 and/or DVR 110 using connection 164. In some embodiments, the portal application 138 may store or otherwise maintain the obtained information regarding the media programming stored by the media device 108 in memory 132.

in the illustrated embodiment of FIG. 1, the on-demand programming source 114 generally represents a provider of media programs for consumption over network 106 on an on-demand basis (either for free or pay-per-view), and in various embodiments, the on-demand programming source 114 may be a studio or other content creator, a syndicator or other content distributor, a television network, a production house, a web or other network-based distributor, and/or any number of other sources as desired. The on-demand programming source 114 and may be realized as any combination of devices, components, modules, servers, hardware, software applications and/or the like that is capable of providing information pertaining to the media programs available for downloading from the on-demand programming source 114. For example, the on-demand programming source 114 may publish or otherwise provide a data feed to the host 102 and/or portal application 138 over the network 106 that includes a listing of media programs available on a pay-per-view basis from the on-demand programming source 114. In some embodiments, the portal application 138 may store or otherwise maintain the obtained information regarding the on-demand media programming available for downloading from on-demand programming source 114 in memory 132.

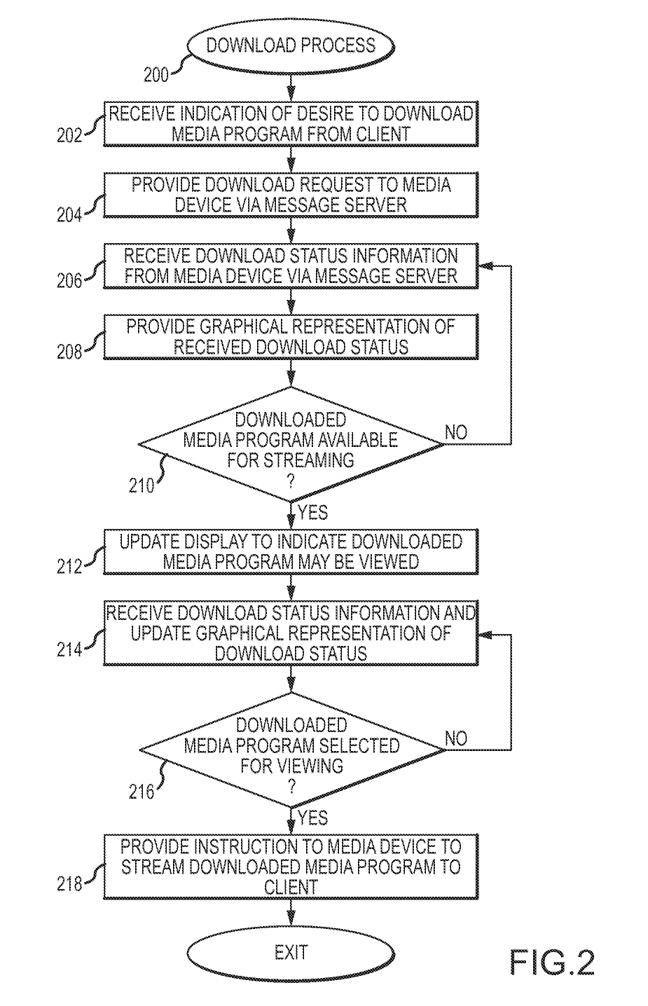

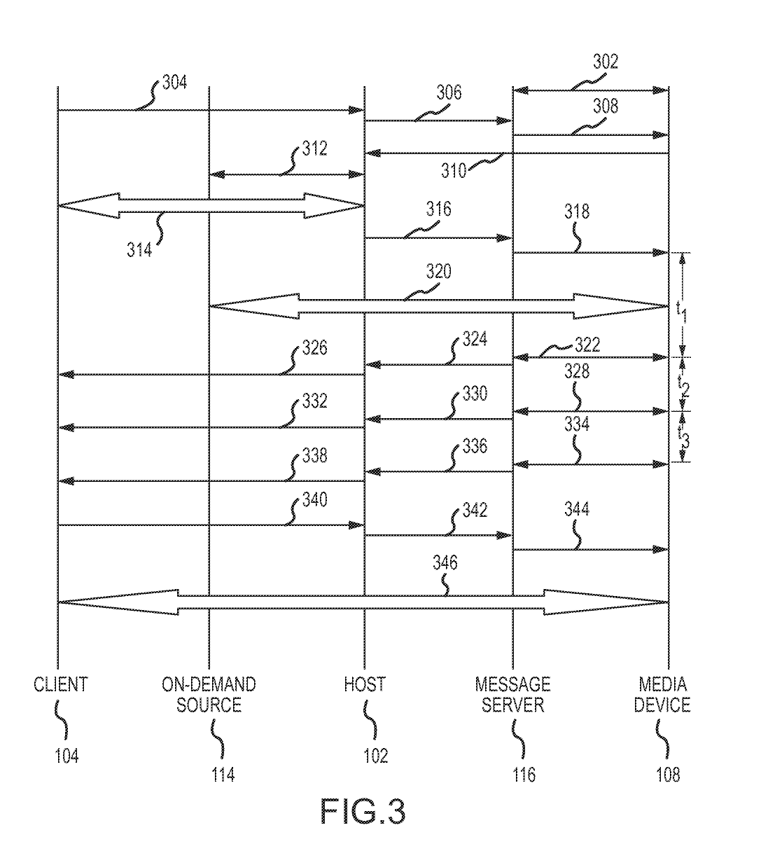

As described in greater detail below in the context of FIGS. 2-3, in various embodiments, the portal application 138 receives or otherwise obtains search criteria provided by the user and identifies instances of media programming satisfying the search criteria that are available within the media distribution system 100. In this regard, the portal application 138 may include search engine configured to implement one or more search processes using the user-specified search criteria to identify instances of media programming satisfying the search criteria that are available from one or more of the content sources 110, 112, 114 within the media distribution system 100. For example, the portal application 138 may identify a media program available from the on-demand programming source 114 that satisfies the user's search criteria and provide a search result to the user (e.g., within browser 105) that indicates the availability of the desired media program satisfying the search criteria from the on-demand programming source 114. As described in greater detail below, the user of the client 104 may select or otherwise indicate, to the portal application 138, a desire to download, view, or otherwise obtain the identified media program from the on-demand programming source 114 that satisfies the user's search criteria (e.g., by manipulating a mouse pointer or other user interface element to select the instance of the identified media program available from on-demand programming source 114 from the search result presented within browser 105). In response to receiving an instruction or indication from the client 104 to obtain the desired media program from the on-demand programming source 114, the host 102 and/or portal application 138 provides a download request and/or other instructions to the message server 116, via connection 162, to initiate a download of the desired media program from the on-demand programming source 114 to the media device 108. The message server 116 provides the download request and/or instructions to the media device 108, via connection 160, to establish a communication session with on-demand programming source 114 and download the desired media program, wherein in response to receiving instructions from the message server 116, the media device 108 establishes a connection 170 to the on-demand programming source 114 over the network 106 and begins downloading the desired media program from the on-demand programming source 114 to the DVR 110.

As described in greater detail below, in an exemplary embodiment, the message server 116 periodically requests or otherwise obtains, from media device 108 via connection 160, status information pertaining to the download of the desired media program (e.g., the download progress and the data rate for connection 170) and provides the obtained download status information to the portal application 138 and/or host 102 via connection 162. In response to receiving the download status information from the message server 116, the portal application 138 and/or host 102 may display, within browser 105 on the client 104, a graphical representation of the download status information, and in certain situations, when the media program being downloaded is available for streaming from the media device 108 and capable of being viewed by the user of the client 104. Once the media program is capable of being viewed, the user of the client 104 may indicate, to the portal application 138 and/or host 102, a desire to view or stream the downloaded media program, and in response, the portal application 138 and/or host 102 provides instructions to the message server 116, via connection 162, to initiate a streaming of the downloaded media program from the DVR 110 and/or media device 108 to the client 104. The message server 116 provides the streaming instructions to the media device 108, via connection 160, wherein in response to receiving streaming instructions from the message server 116, the media device 108 establishes a connection 180 to the client 104 over the network 106 and begins streaming the downloaded media program from the DVR 110 to the media player 107.

Turning now to FIG. 2, in an exemplary embodiment, a media distribution system 100 may be configured to perform a download process 200 and additional tasks, functions, and operations described below. The various tasks may be performed by software, hardware, firmware, or any combination thereof. For illustrative purposes, the following description may refer to elements mentioned above in connection with FIG. 1. In practice, the tasks, functions, and operations may be performed by different elements of the media distribution system 100, such as, for example, the host 102, the client 104, the browser 105, the media player 107, the media device 108, the on-demand programming source 114, the message server 116 and/or the portal application 138. It should be appreciated that any number of additional or alternative tasks may be included, and may be incorporated into a more comprehensive procedure or process having additional functionality not described in detail herein.

Referring to FIG. 2, and with continued reference to FIG. 1, the download process 200 begins by receiving, from a client device, a download request indicating a desire to download a media program from a content source within the media distribution system (task 202). As described above, after the portal application 138 authenticates the user of the client device 104, the portal application 138 and/or host 102 obtains information pertaining to the media programming available from the various content sources 110, 112, 114 within the media distribution system 100. Subsequently, the portal application 138 may receive or otherwise obtain search criteria from the user of the client device 104, identify a media program satisfying the search criteria that is available for download from the on-demand programming source 114, and display or otherwise present a graphical representation of the search result indicating availability of the media program satisfying the user's search criteria from the on-demand programming source 114. The user of the client 104 manipulates one or more user interface elements (e.g., a mouse, keyboard, or the like) to select the instance of the identified media program available from the on-demand programming source 114 to provide a download request to the portal application 138 and/or host 102 that indicates a desire to download the identified media program from the on-demand programming source 114 to the user's media device 108 and/or DVR 110.

In response to receiving indication of a desire to download a media program, the download process 200 continues by instructing or otherwise commanding the user's media device to download or otherwise obtain the media program from the content source (task 204). As described above, the host 102 and/or portal application 138 provides the download request and/or other instructions to the message server 116, via connection 162, for downloading the media program from the on-demand programming source 114 to the media device 108. The download request provided by the portal application 138 may include information for locating or otherwise identifying the on-demand programming source 114 (e.g., an IP address, a URL, and/or other network configuration information) along with information identifying the desired media program from among the other media programming available from the on-demand programming source 114. The message server 116 provides the download request and/or instructions received from the host 102 and/or portal application 138 to the media device 108, via connection 160. In response to receiving the download request, the media device 108 establishes a communication session with the identified on-demand programming source 114 and begins downloading the identified media program from the on-demand programming source 114 to the DVR 110 over the network 106 via connection 170.

In an exemplary embodiment, the download process 200 continues by receiving, from the message server, status information pertaining to the download of the desired media program and providing, to the client device, a graphical representation of the download status information received from the message server (tasks 206, 208). In this regard, in an exemplary embodiment, after providing the download request to the media device 108, the message server 116 polls or otherwise requests the media device 108 for information pertaining to the status of the downloaded media program, such as, for example, the download progress (e.g., the amount or percentage of the media program that has been downloaded to the DVR 110), the data rate (or bit rate) for the data being received from the on-demand programming source 114 over connection 170, and the like. For example, the message server 116 may be configured to transmit a status request to the media device 108 at some time interval (e.g., one minute) after providing the download request to the media device 108. In response to receiving the request for download status information from the message server 116, the media device 108 provides the requested download status information (e.g., the download progress, the data rate for connection 170, and the like) to the message server 116. In response to receiving the requested download status information from the media device 108, the message server 116 is configured to provide the received download status information to the portal application 138 and/or host 102. In response to receiving download status information from the message server 116, the portal application 138 and/or host 102 presents or otherwise displays, on the client 104 (e.g., within browser 105) a graphical representation of the received download status information. For example, the portal application 138 may display, within browser 105, a progress bar that reflects the download progress (e.g., the amount or percentage of the media program that has been downloaded to the DVR 110 from on-demand programming source 114) for the desired media program.

In an exemplary embodiment, the download process 200 continues by determining whether the media program being downloaded to the media device from the content source is capable of being streamed, viewed, or otherwise presented on the client device (task 210). For example, based on the amount or percentage of the media program that has been downloaded to the DVR 110 and/or the data rate between the on-demand programming source 114 and the media device 108, the portal application 138 determines whether the downloaded media program is capable of being streamed from the DVR 110 and/or media device 108 to the client 104 for presentation of the downloaded media program to the user with a sufficiently high likelihood of providing a quality viewing experience (e.g., without buffer underrun, latencies, or other effects impairing or otherwise interrupting presentation of the downloaded media program on the client 104). In this regard, if the amount or percentage of the media program that has been downloaded to the DVR 110 is too small and/or the data rate between the on-demand programming source 114 and the media device 108 is too slow (or a combination thereof), the portal application 138 may determine that the media program is not capable of being streamed from the DVR 110 and/or media device 108 to the client 104 due to a sufficiently high likelihood of buffer underrun, latencies, or other effects impairing or otherwise interrupting presentation of the downloaded media program on the client 104.

When the download process 200 determines that the media program being downloaded is not capable of being viewed, streamed, or otherwise presented on the client device, the download process 200 repeats the tasks of receiving download status information and providing a graphical representation of the download status information on the client (tasks 206, 208). In an exemplary embodiment, the message server 116 is configured to periodically poll or otherwise request download status information from the media device 108 at regular intervals while the media device 108 is downloading the media program from the on-demand programming source 114. For example, the message server 116 may periodically transmit status requests to the media device 108 at one minute intervals while the media device 108 is downloading the media program from the on-demand programming source 114. As described above, each time the media device 108 receives the status request, the media device 108 provides the requested download status information to the message server 116, which, in turn, is configured to provide the download status information received from the media device 108 to the portal application 138 and/or host 102. In response to receiving updated download status information, the portal application 138 and/or host 102 dynamically updates the graphical representation of the download status on the client 104 each time updated download status information is received, such that the graphical representation of the download status reflects the most recently received download status information. For example, each time the portal application 138 receives download status information from the message server 116, the portal application 138 may update the progress bar to reflect the current percentage of the media program that has been downloaded to the DVR 110 from on-demand programming source 114. In some embodiments, the loop defined by tasks 206, 208 and 210 will repeat until the download is completed and the entirety of the media program has been downloaded to the DVR 110 (e.g., when the data rate over connection 170 is too slow to allow streaming to the client 104 while downloading).

In response to determining the media program being downloaded to the media device from the content source is capable of being viewed, streamed, or otherwise presented on the client device, in an exemplary embodiment, the download process 200 continues by updating the display on the client device to indicate availability of the downloaded media program for streaming and/or viewing on the client device (task 212). As described above, the portal application 138 may determine that the media program is capable of being streamed from the DVR 110 and/or media device 108 to the client 104 when the amount or percentage of the media program that has been downloaded to the DVR 110 and/or the data rate between the on-demand programming source 114 and the media device 108 (or a combination thereof) is great enough such that there is a sufficiently low likelihood of buffer underrun, latencies, or other effects impacting presentation of the downloaded media program on the client 104. In response to determining the media program is capable of being streamed from the DVR 110, the portal application 138 may present or otherwise display on the client 104 (e.g., within browser 105) a graphical user interface element, such as a button, that a user may manipulate or otherwise select to indicate a desire to view the downloaded media program. In some embodiments, the portal application 138 may display the graphical user interface element in a deactivated state prior to determining that the media program is capable of being streamed from the DVR 110, such that the user can view the graphical user interface element but is either unable to manipulate or otherwise select the graphical user interface element or any attempted manipulation of the graphical user interface element is effectively ignored, thereby indicating the unavailability of the downloaded media program for streaming and/or viewing on the client device 104. In response to determining that the media program is capable of being streamed from the DVR 110, the portal application 138 activates the graphical user interface to allow the user to manipulate or otherwise select the graphical user interface element to begin streaming the downloaded media program, thereby indicating the availability of the downloaded media program for streaming to the client device 104. In an exemplary embodiment, the download process 200 continues receiving download status information and updating the graphical representation of the download status until the media program is completely downloaded to the media device (task 212), in a similar manner as described above (e.g., tasks 206, 208). In accordance with one or more embodiments, the message server 116 monitors the download progress, and in response to determining that the media program has been completely downloaded, stops requesting download status information from the media device 108, that is, the message server 116 does not send any additional status requests pertaining to the media program of interest.

In an exemplary embodiment, the download process 200 determines whether the media program being downloaded to the media device has been selected for viewing on the client device, and in response to determining the media program is selected for viewing, provides instructions to the media device for presenting the downloaded media program on the client device (task 216, 218). In this regard, a user of the client device 104 may manipulate or otherwise select the graphical user interface element displayed within the browser 105 that was used by the portal application 138 to indicate availability of the downloaded media program for streaming to the client device 104, wherein the portal application 138 determines or otherwise identifies selection of the downloaded media program for viewing on the client 104 in response to the user manipulating the graphical user interface element. In response to receiving indication of a desire to stream, view, or otherwise present the downloaded media program on the client 104, the portal application 138 and/or host 102 provides a streaming request and/or instructions to the message server 116, via connection 162, for streaming the media program from the DVR 110 and/or media device 108 to the client 104. The streaming request provided by the portal application 138 may include information for locating or otherwise identifying the client 104 over the network 106 (e.g., an IP address, a URL, and/or other network configuration information) along with information identifying the downloaded media program as the media programming stored on the DVR 110 and/or media device 108 that is to be streamed to the client 104. The message server 116 provides the streaming request and/or instructions received from the host 102 and/or portal application 138 to the media device 108, via connection 160. In response to receiving the streaming request, the media device 108 creates a placeshifting session by establishing the connection 180 to the client 104 (e.g., using the location information from the streaming request) and begins streaming the downloaded media program from the DVR 110 to the client 104 over the network 106 via connection 180. The client 104 receives the streamed media program and presents or otherwise displays the streamed media program within media player 107 and/or browser 105. In the event the media program being streamed has not been completely downloaded from the on-demand programming source 114 to the media device 108, the media device 108 concurrently downloads the media program from the on-demand programming source 114 via connection 170 and the portal application 138 and/or host 102 may continue receiving download status information from the media device 108 via message server 116 and updating the graphical representation of the download status within browser 105 (e.g., in the background behind media player 107) until the media program has been completely downloaded to the DVR 110 from on-demand programming source 114. As described above, by virtue of the portal application 138 determining the media program may be reliably streamed from the DVR 110 to the client 104 based on the amount of the media program that has been downloaded to the DVR 110 and/or the data rate between the on-demand programming source 114 and the media device 108, the user of the client 104 may be ensured a quality viewing experience when placeshifting the partially downloaded media program.

FIG. 3 illustrates an exemplary sequence of communications within the media distribution system 100 in accordance with an exemplary embodiment of the download process 200. As described above, in an exemplary embodiment, the media device 108 automatically exchanges information 302 with the message server 116 to establish a persistent connection 160. Subsequently, a user of client 104 may activate a web browser application 105, provide a known URL or other address that is associated with the portal application 138 and/or host 102 to establish a connection to the portal application 138 and/or host 102, and provide information 304 to be used to authenticate the user and/or identify the media device 108 associated with the user. After authenticating the user and identifying the user's media device 108, the portal application 138 and/or host 102 provides a request 306 for obtaining information pertaining to media programming stored at the media device 108 (e.g., on DVR 110) to the message server 116. The message server 116 transmits or otherwise provides the request 308 to the media device 108, via connection 160, and in response to receiving the request 308, the media device 108 establishes the connection 164 to the host 102 and transmits or otherwise provides information 310 to the portal application 138 and/or host 102 pertaining to the media programs stored on media device 108 and/or DVR 110. In an exemplary embodiment, in addition to obtaining a listing of media programs stored on the media device 108 and/or DVR 110, the portal application 138 and/or host 102 also accesses the on-demand programming source 114 over the network 106 to obtain information 312 pertaining to the media programs available for downloading from on-demand programming source 114 to the user's media device 108 and/or DVR 110. Although not illustrated in FIG. 3, the portal application 138 and/or host 102 may also access an electronic program guide or a similar feature to obtain information pertaining to the media programs available from broadcast source 112. After obtaining information pertaining to the media programs available from the various content sources 110, 112, 114 in the media distribution system 100, the portal application 138 establishes an interactive session 314 with the client 104 over the network 106 to facilitate interaction between the user of the client 104 and the media distribution system 100, for example, to search for media programming available within media distribution system 100, schedule recordings of upcoming airings of media programs by broadcast source 112 to the user's DVR 110, delete existing recordings from the user's DVR 110, stream, view, or otherwise placeshift media programs from the user's DVR 110 to the client 104, download media programs from on-demand programming source 114 to the user's DVR 110, modify user preferences and/or settings, or to take other actions related to media device 108 as desired.

As described above, in an exemplary embodiment, during the interactive session 314, the portal application 138 receives search criteria from the user of the client device 104, identifies a media program satisfying the search criteria that is available for downloading from on-demand programming source 114, and provides a search result on the client 104 (e.g., within browser 105) indicating availability of the media program satisfying the user's search criteria from the on-demand programming source 114. In response to receiving indication of a desire to download the identified media program, the portal application 138 and/or host 102 provides, to the message server 116 via connection 162, a download request 316 including location information for the on-demand programming source 114 and identifying information for the media program to be downloaded. The message server 116 transmits the download request 318 to the media device 108 via connection 160. In response to receiving the download request 318, the media device 108 establishes a communication session 320 with the on-demand programming source 114 and begins downloading the identified media program from the on-demand programming source 114 to the DVR 110 over the network 106 via connection 170.

After providing the download request 318 to the media device 108, the message server 116 waits for some predetermined amount of time (t₁) before transmitting a status request and communicating with the media device 108 via connection 160 to obtain download status information 322 for the media program being downloaded to the DVR 110 as part of communication session 320. After receiving download status information 322 from the media device 108, the message server 116 provides the obtained download status information 324 to the portal application 138 and/or host 102, and the portal application 138 and/or host 102 provides the received download status information 326 to the user of the client 104, for example, by displaying a progress bar or the like within browser 105 to reflect the progress of the download of the media program. After obtaining initial download status information 322 from the media device 108, the message server 116 waits for another amount of time (t₂) before transmitting another status request and communicating with the media device 108 via connection 160 to obtain updated download status information 328. The message server 116 provides the updated download status information 330 to the portal application 138 and/or host 102, wherein the portal application 138 and/or host 102 provides the updated download status information 332 to the client 104, for example, by updating the progress bar to reflect the updated download status. While the media program is still being downloaded to the DVR 110, the message server 116 waits for another amount of time (t₃) before transmitting another status request and communicating with the media device 108 via connection 160 to obtain updated download status information 334. In a similar manner, as described above, the message server 116 provides the updated download status information 336 to the portal application 138 and/or host 102, and the portal application 138 and/or host 102 provides the updated download status information 338 to the client 104, for example, by updating the progress bar again. As described above, in an exemplary embodiment, the message server 116 obtains download status information at regular intervals (e.g., t₁=t₂=t₃), and the steps of obtaining updated download status information from the media device 108, providing the updated download status information to the portal application 138 and/or host 102, and updating the graphical representation of the download status information on the client 104 may be repeated until the media program is completely downloaded to the media device 108 and/or DVR 110, at which point, the media device 108 and/or on-demand programming source 114 may terminate the connection 170 and/or communication session 320.

As described above, during and/or after downloading the media program, the portal application 138 and/or host 102 may determine that the media program is capable of being streamed from the DVR 110 and/or media device 108 to the client 104, and update the display within browser 105 to activate or display a graphical user interface element indicating availability of the downloaded media program for streaming to the client 104 and allowing a user of the client 104 to initiate streaming of the downloaded media program from the media device 108 to the client 104. The user of the client 104 may manipulate or otherwise select the graphical user interface element presented within browser 105 to provide, to the portal application 138 and/or host 102, a request 340 for streaming or otherwise viewing the downloaded media program on the client 104. In response to receiving the request 340 from the client 104, the portal application 138 and/or host 102 provides a streaming request 342 to the message server 116, which, in turn, transmits the streaming request 344 to the media device 108. In response to receiving the streaming request 344, the media device 108 creates a placeshifting session 346 by establishing the connection 180 to the client 104 and begins streaming the downloaded media program from the DVR 110 to the client 104 over the network 106 via connection 180, wherein the client 104 receives the streamed media program and presents or otherwise displays the streamed media program within media player 107 and/or browser 105.

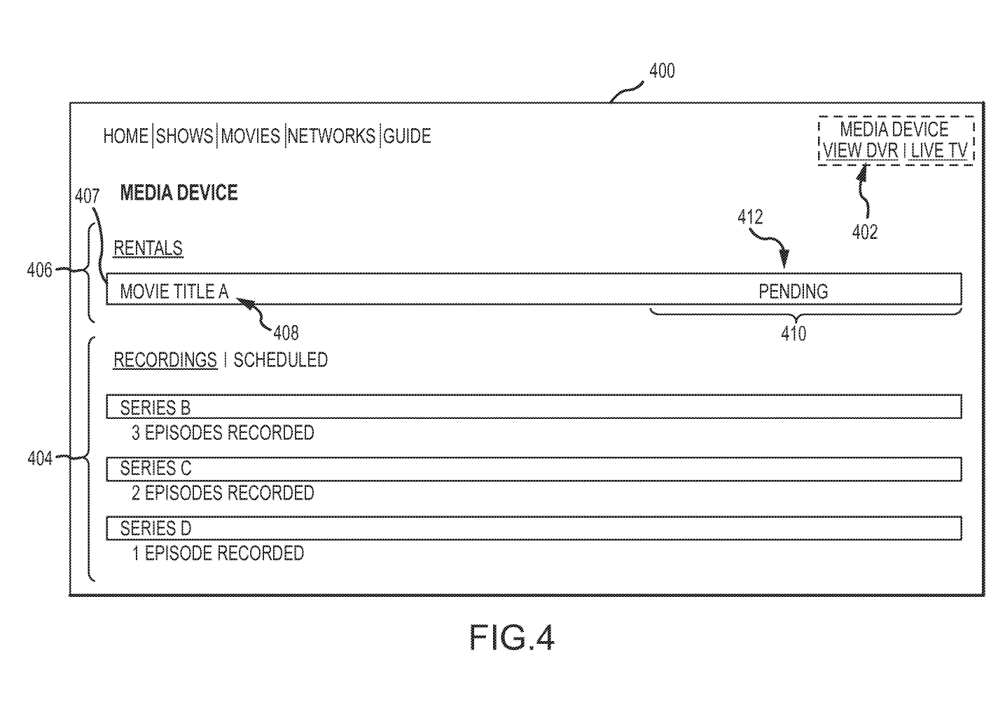

FIGS. 4-7 illustrate an exemplary sequence of a user interface display 500 that may be presented by the portal application 138 on the client device 104 (e.g., within browser 105) in the media distribution system 100 of FIG. 1 in connection with an exemplary embodiment of the download process 200 of FIG. 2. Referring to FIGS. 4-7, and with continued reference to FIGS. 1-3, as described above, in an exemplary embodiment, after the portal application 138 authenticates the user of the client device 104, the portal application 138 may receive or otherwise obtain search criteria from the user of the client device 104 indicative of media program “MOVIE TITLE A” and identify an instance of “MOVIE TITLE A” available for download from the on-demand programming source 114. After the user of the client 104 selects or otherwise indicates a desired to download the instance of “MOVIE TITLE A” from the on-demand programming source 114, the portal application 138 provides, to the message server 116, the download request and/or other instructions for downloading “MOVIE TITLE A” from the on-demand programming source 114.

Turning to FIG. 4, when a user selects a graphical user interface element 402, such as a hyperlink, button, or the like, to view media programming available on the user's DVR 110, the portal application 138 presents the display 400, which includes a region 404 containing graphical representations of the media programming recorded (or scheduled to be recorded) by the DVR 110 and/or media device 108 from the broadcast source 112 and another region 406 containing graphical representations of the media programming obtained by the DVR 110 and/or media device 108 from the on-demand programming source 114. In this regard, the region 406 of the display 400 includes an entry 407 having textual information 408 indicating the selected media program “MOVIE TITLE A”. Prior the message server 116 obtaining and providing status information pertaining to the download of “MOVIE TITLE A” from the on-demand programming source 114, the portal application 138 may display, within a status region 410 of the “MOVIE TITLE A” entry 407, textual information 412 indicating that the current status of the download is pending.

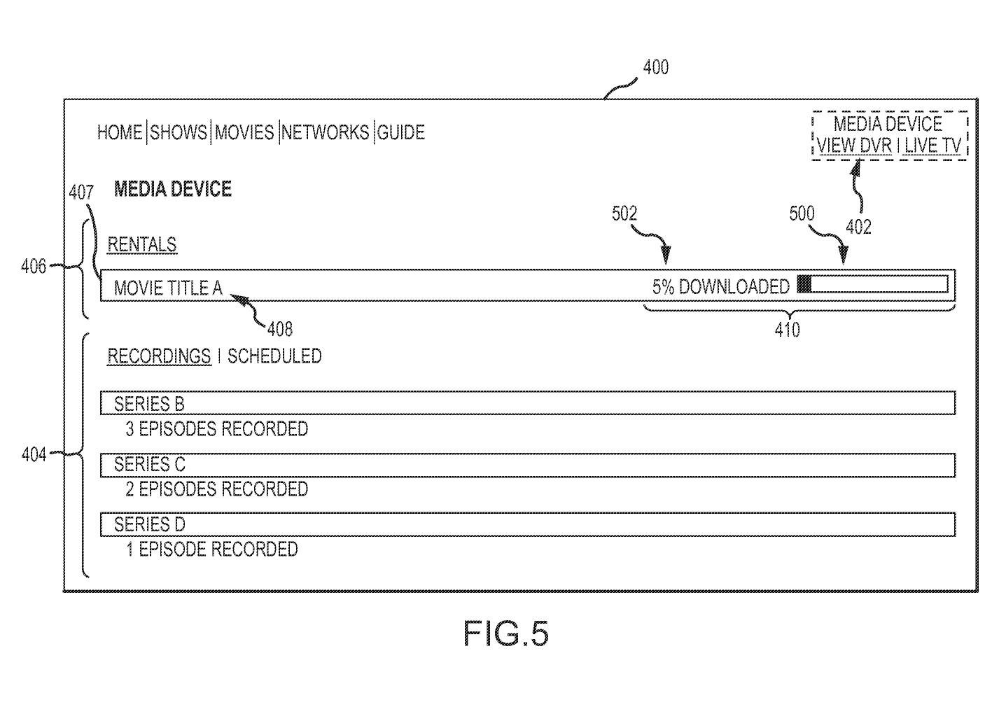

Turning now to FIG. 5, as described above, the message server 116 polls or otherwise requests download status information for “MOVIE TITLE A” from the media device 108 at some time interval (e.g., one minute) after providing the download request to the media device 108, wherein in response to receiving the request for download status information from the message server 116, the media device 108 provides the requested download status information to the message server 116, which, in turn, provides the received download status information to the portal application 138. In response to receiving download status information from the message server 116, the portal application 138 updates the status region 410 and presents or otherwise displays, within the status region 410 in lieu of textual information 412, a progress bar 500 that graphically represents the amount or percentage of “MOVIE TITLE A” that has been downloaded to the DVR 110 from on-demand programming source 114. Additionally, the portal application 138 may display, proximate the progress bar 500 within the status region 410, textual information 502 indicative of the amount or percentage of “MOVIE TITLE A” that has been downloaded. It should be noted that in some embodiments, the textual information 502 may also include the data rate of connection 170 or other download status information obtained from the message server 116.

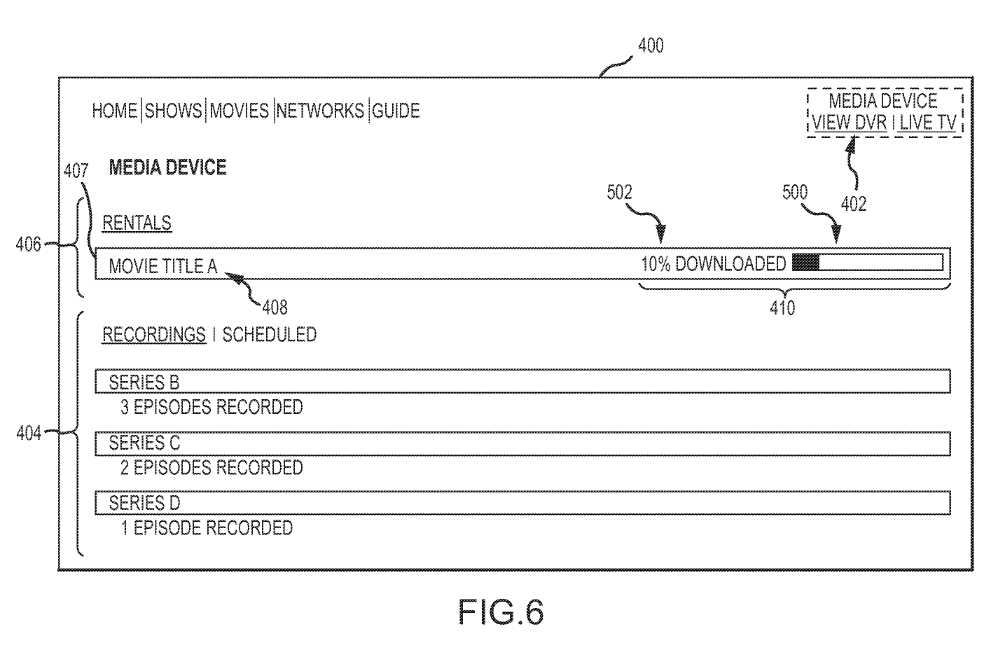

As described above, in an exemplary embodiment, the message server 116 repeatedly polls or otherwise requests download status information for “MOVIE TITLE A” from the media device 108 at periodic intervals to obtain updated download status information for “MOVIE TITLE A” from the media device 108. In response to receiving updated download status information from the media device 108, the message server 116 provides the updated download status information to the portal application 138. As illustrated by FIG. 6, in response to receiving updated download status information from the message server 116, the portal application 138 updates the progress bar 500 and the textual information 502 to reflect the most recently received download status information for “MOVIE TITLE A”.

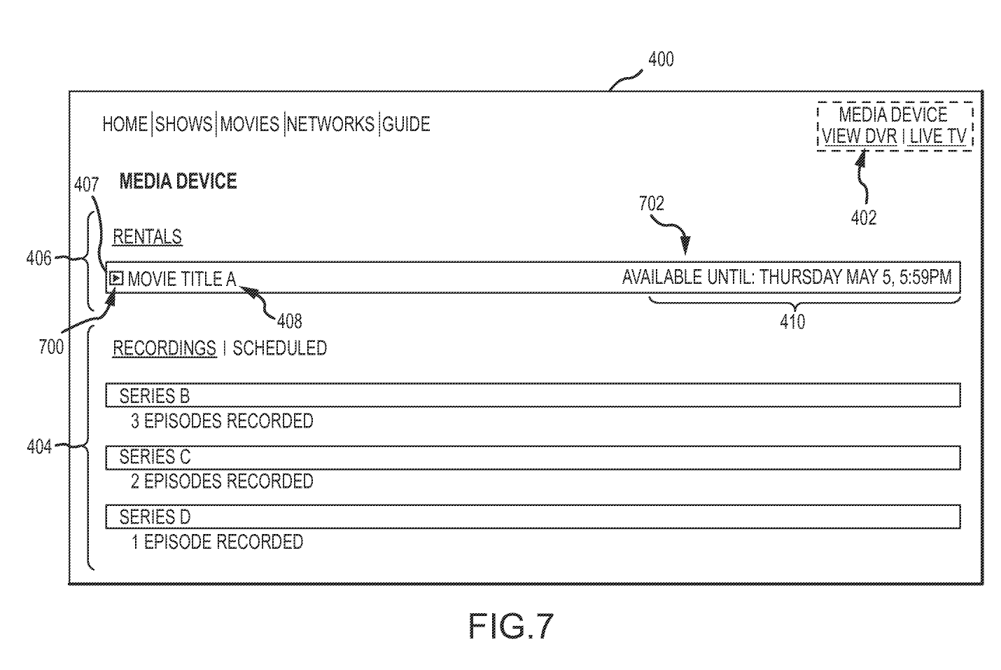

Referring now to FIG. 7, as described above, in an exemplary embodiment, each time the portal application 138 receives download status information from the message server 116, the portal application 138 determines whether “MOVIE TITLE A” is capable of being streamed, viewed, or otherwise presented on the client 104 based on the amount or percentage of “MOVIE TITLE A” that has been downloaded to the DVR 110, the data rate between the on-demand programming source 114 and the media device 108, and/or other factors. When the portal application 138 determines “MOVIE TITLE A” is capable of being streamed from the DVR 110 and/or media device 108 to the client 104, the portal application 138 may update the display 400 to include a graphical user interface element 700, such as a button or the like, associated with the “MOVIE TITLE A” entry 407 that is adapted to allow placeshifting and viewing “MOVIE TITLE A” on the client 104. Additionally, the portal application 138 may update the display 400 by removing or otherwise replacing the graphical representations 500, 502 of the received download status information and displaying, within the entry 407, metadata and/or other information 702 associated with the instance of “MOVIE TITLE A” downloaded from the on-demand programming source 114, such as, for example, availability information, in place of the progress bar 500 and/or textual information 502. It should be noted however, that in some embodiments, the portal application 138 may continue displaying and updating the progress bar 500 and/or textual information 502 until the download of “MOVIE TITLE A” is completed before replacing the progress bar 500 and/or textual information 502 with the metadata and/or other information 702.

As described above in the context of FIGS. 2-3, a user may desire to view the downloaded instance of “MOVIE TITLE A” from the user's DVR 110, in which case, the user may interact with the media device 108 and/or DVR 110 over the network 106 using the button 700 displayed by the portal application 138 to indicate a desire to placeshift and view the downloaded instance of “MOVIE TITLE A” on the client device 104. In response to a user selecting or otherwise manipulating the button 700 to indicate a desire to play the downloaded instance of “MOVIE TITLE A”, the portal application 138 creates a placeshifting session by providing a streaming request and/or instructions to the message server 116, via connection 162, for streaming “MOVIE TITLE A” from the DVR 110 and/or media device 108 to the client 104. The message server 116 provides the streaming request and/or instructions received from the host 102 and/or portal application 138 to the media device 108, via connection 160. In response to receiving the streaming request, the media device 108 creates a placeshifting session by establishing the connection 180 to the client 104 and begins streaming “MOVIE TITLE A” from the DVR 110 to the client 104 over the network 106 via connection 180. The client 104 presents or otherwise displays “MOVIE TITLE A” within media player 107 and/or browser 105, and the user of the client 104 may be ensured a quality viewing experience by virtue of the portal application 138 predetermining that “MOVIE TITLE A” may be reliably streamed from the DVR 110 in the event “MOVIE TITLE A” is not completely downloaded.

The general systems, structures and techniques described above may be inter-combined, enhanced, modified and/or otherwise implemented to provide any number of different features. In particular, the term “exemplary” is used herein to represent one example, instance or illustration that may have any number of alternates. Any implementation described herein as “exemplary” should not necessarily be construed as preferred or advantageous over other implementations.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting. For example, terms such as “first,” “second” and other such numerical terms referring to structures do not imply a sequence or order unless clearly indicated by the context.

While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method executable by a processing system to monitor a download of a media program to a media device over a network, the method comprising:
providing, to a server communicating with the media device over the network, a download request for downloading the media program to the media device from a content source coupled to the network;
receiving, from the server, status information for the download of the media program by the media device; and
displaying, on a client coupled to the network, a graphical representation of the status information received from the server.

2. The method of claim 1, further comprising receiving, from the client, a request to download the media program from the content source, the processing system providing the download request to the server in response to receiving the request from the client, the server providing the download request to the media device, and the media device downloading the media program from the content source in response to the download request from the server.

3. The method of claim 1, the status information including a download progress for the media program downloaded to the media device, wherein displaying the graphical representation comprises displaying a progress bar indicative of the download progress.

4. The method of claim 1, further comprising:
determining availability of the media program for streaming from the media device to the client; and
providing, on the client, indication of the availability of the media program.

5. The method of claim 4, wherein providing indication of the availability of the media program comprises displaying, on the client, a graphical user interface element adapted to allow a user of the client to initiate streaming of the media program from the media device to the client.

6. The method of claim 5, further comprising providing, to the server, instructions for streaming the media program from the media device to the client in response to activation of the graphical user interface element, wherein:
the server provides streaming instructions for the media program to the media device; and
the media device establishes, over the network, a placeshifting session with the client in response to receiving the streaming instructions.

7. The method of claim 4, the status information including a download progress of the media program being downloaded to the media device, wherein determining the availability comprises determining the availability of the media program for streaming based on the download progress.

8. The method of claim 4, the status information including a data rate between the media device and the content source, wherein determining the availability comprises determining the availability of the media program for streaming based on the data rate.

9. The method of claim 1, further comprising
receiving, from the server, updated status information for the download of the media program by the media device; and
updating the graphical representation displayed on the client to reflect the updated status information received from the server.

10. A method executable by a message server coupled to a network, the method comprising:
receiving, from a host server coupled to the network, a download request for a media program available from a content source coupled to the network;
providing the download request to a media device coupled to the network, the media device downloading the media program from the content source in response to the download request; and
after providing the download request to the media device:
obtaining download status information for the media program from the media device; and
providing the download status information to the host server.

11. The method of claim 10, further comprising establishing a persistent connection to the media device, wherein the download request is provided via the persistent connection.

12. The method of claim 10, wherein obtaining the download status information comprises providing, to the media device, a status request for the downloading of the media program from the content source, the media device providing the download status information to the message server in response to the status request.

13. The method of claim 12, further comprising establishing a persistent connection to the media device, wherein the status request is provided via the persistent connection.

14. The method of claim 10, wherein obtaining the download status information comprises obtaining an amount of the media program downloaded to the media device, the host server providing a graphical representation of the amount on a client device coupled to the network in response to receiving the amount from the message server.

15. The method of claim 10, wherein obtaining the download status information comprises periodically providing, to the media device, status requests for the downloading of the media program from the content source, the media device providing download status information to the message server in response to each status request.

16. A system that communicates via a network with a client and a media device, the system comprising:
a message server coupled to the network to establish a connection with the media device over the network; and
a host server coupled to the network and communicating with the message server and the client via the network to:
receive, from the client, indication of a media program available from a content source coupled to the network;
provide a download request for the media program to the message server, the message server providing the download request to the media device via the connection and the media device downloading the media program from the content source over the network in response to the download request;
receive, from the message server, status information for the downloading of the media program to the media device; and
provide the status information to the client.

17. The system of claim 16, wherein the message server is configured to:
provide, to the media device, a status request for the downloading of the media program, the media device providing the status information to the message server in response to the status request; and
provide the status information to the host server.

18. The system of claim 16, wherein the message server is configured to:
periodically provide, to the media device, status requests for the downloading of the media program, the media device providing status information to the message server in response to each status request; and
provide the status information provided by the media device in response to each status request to the host server.

19. The system of claim 18, wherein the host server is configured to provide the status information to the client by displaying a graphical representation of the status information on the client, the graphical representation being updated to reflect the status information provided by the media device in response to each status request.

20. A media device comprising:
a network interface configured to support a first connection with a message server over a network and a second connection with a content source over the network;
a data storage medium coupled to the network interface; and
a control module coupled to the network interface and the data storage medium, wherein the control module and the network interface are cooperatively configured to initiate a download of the media program from the content source to the data storage medium via the second connection in response to a download request from the message server, receive a status request from the message server, and provide download status information to the message server in response to the status request, the message server providing the download status information to a host server coupled to the network for provision to a client device coupled to the network.
